(19) United States
(12) Patent Application Publication
(10) Pub. No.: US 2005/0041144 A1
(43) Pub. Date: Feb. 24, 2005

(54) Recyclable digital camera

(76) Inventors: Colin Mitchell, Auckland, (NZ); Richard William Ross Urwin, New South Wales (AU); Justin David Wright, New South Wales (AU)

Correspondence Address: YOUNG & THOMPSON, 745 SOUTH 23RD STREET, 2ND FLOOR, ARLINGTON, VA, 22202, US

(21) Appl. No.: 10/497,309

(22) PCT Filed: Dec. 2, 2002
(86) PCT No.: PCT/NZ02/00267

(30) Foreign Application Priority Data
Nov. 30, 2001 (NZ) 515848

(51) Int. Cl. H04N 5/225

(52) U.S. Cl. 348/376; 348/220.1; 348/231.7

(57) ABSTRACT

A recyclable digital camera including a casing, a lens housed within the casing, an encoding device arranged to encode information from the lens into a format suitable for storing in a storage device, a storage device arranged to store information from the encoder, and a controller arranged to encrypt information from the encoding device before the information is stored in the storage device, then a controller further arranged to delete information from the storage device and record over the storage device with random information upon request.

### FIELD OF INVENTION

The invention relates to cameras and in particular to digital cameras able to take both still and video images that can be recycled.

### BACKGROUND

Digital cameras make use of an optical sensor, behind a lens, the optical sensor converting the image into a number of digital pixels. This digital picture information is then stored in an appropriate storage medium. In the case of digital video cameras, the storage medium is typically tape, although some cameras will store the information on disk. In the case of digital still cameras, the storage medium is electronic memory, typically some form of random access memory often in the form of a memory card, sometimes in the form of a memory stick. In most cases, the memory device, whether it is a card or a memory stick, is removable and can be transferred to other digital devices. In all cases, these digital cameras are expensive, and compete in price and performance with conventional film based still cameras, or conventional analog video cameras.

### SUMMARY OF INVENTION

It is an object of this invention to provide a recyclable digital video and/or stills camera or to at least provide the public with a useful choice.

In broad terms in one aspect the invention comprises a recyclable digital camera including a casing, a lens housed within the casing, an encoding device arranged to encode information from the lens into a format suitable for storing in a storage device, a storage device arranged to store information from the encoder, and a controller arranged to encrypt information from the encoding device before the information is stored in the storage device, the controller further arranged to delete information from the storage device and record over the storage device with random information upon request.

In broad terms in a further aspect of the invention includes a recyclable digital camera including a casing surrounding an image module housing a lens, an image viewer, microphone, auditory circuitry, an encoding device arranged to encode information from the lens into a format suitable for storing in a storage device, the camera further including a casing surrounding a memory module housing at least one power source, a storage device arranged to store information from the encoder, and a controller arranged to encrypt information from the encoding device before the information is stored in the storage device, the controller further arranged to delete information from the storage device and record over the storage device with random information upon request and wherein the memory module and the image module communicate with each other to store images.

In broad terms in a further aspect the invention comprises a recyclable digital camera including a casing, a lens housed within the casing, an encoding device arranged to encode information from the lens into a format suitable for storing in a storage device, a storage device arranged to store information from the encoder and a controller arranged to allow the memory to become filled with images and then to prevent further images being stored on the storage device and prevent deletion of images from the storage device until a predetermined instruction is received.

In broad terms in a further aspect the invention comprises a camera engage system including a plurality of single use digital cameras each camera able to record both video and still images, each camera including a controller that encrypts the images stored in memory, at least one receiving station arranged to read the images from a camera memory, decrypt the images and provide the images to a user in a required form, and at least one recycling station for recycling used cameras by at least replacing the camera case.

In broad terms in a further aspect the invention comprises a camera exchange method including providing a plurality of single use digital cameras each camera able to record both video and still images, each camera including a controller arranged to encrypt the images stored in the memory of the camera, receiving at least one camera at a receiving station the receiving station arranged to read the images from the camera memory, decrypt the images and provide the images to a user in a required form and recycling the at least one camera at a recycling station.

### BRIEF DESCRIPTION OF THE DRAWINGS

A preferred form system and method of the invention will be further described with reference to the accompanying drawings by way of example only and without intending to be limiting wherein:

FIG. 1 illustrates a schematic view of a camera with a factory sealed power supply;

FIG. 2 is a schematic view of the second camera with a removable memory module and removable battery;

FIG. 3 shows a camera with a removable imaging module;

FIG. 4 shows one preferred recycling system of the invention; and

FIG. 5 shows a second preferred recycling system of the invention.

### DETAILED DESCRIPTION OF PREFERRED FORMS

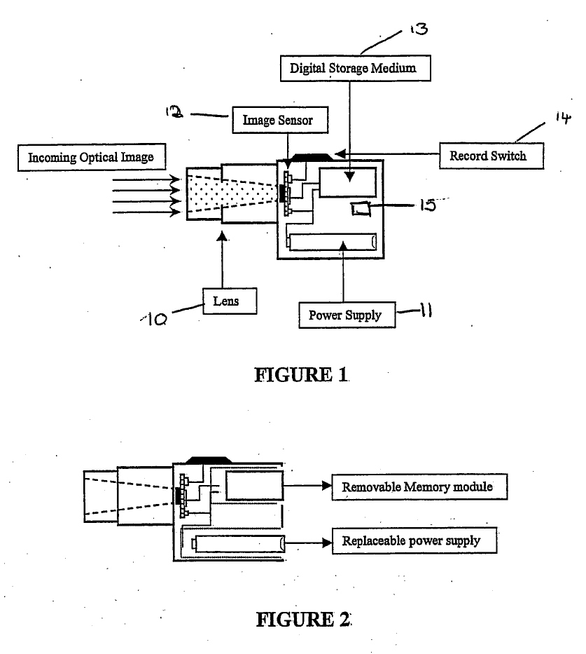

FIG. 1 shows one embodiment of recyclable digital camera. The recyclable digital camera may be of any suitable shape or size and is not restricted to the shape shown in FIG. 1. The recyclable digital camera includes a lens 10 that projects images onto image sensor 12. The recyclable digital camera further includes record switch 14, digital storage medium 13 and power supply 11 and controller 15.

Lens 10 does not need to be designed to be long lasting and may be formed from any suitable material. For example, the lens may be formed from plastics. The lens projects an image onto image sensor 12. The image sensor is arranged so that it only senses images when record switch 14 has been activated. Upon activation of record switch 14 the image sensor senses a single usage or a series of images forming a video, from the lens and encodes this image into a format suitable for storage in the storage medium and transfers it to digital storage medium 13. The controller 15 encrypts the images before the images are stored in the storage medium. Preferably the encryption provided by the controller is a 32 bit rolling key encryption. However other types of encryption may be used. Ideally the encryption key is changed each time the camera is recycled.

It is preferable that the digital storage medium is a solid state memory device such as a random access memory or read only memory, or erasable read only memory, capable of storing a large amount of digital information. In addition to such memory devices, it is possible to use bubble memory, or miniature hard drives, or other types of memory device. However, it is preferable that solid state memory is used. The storage medium provided in the camera may be limited size or limited usable size. For example the storage medium may be arranged to store 15 minutes of view at 640*480 pixels and 30 frames per second, and 27 still images at 1280*960 pixels. Storage mediums with different sizes and different usable sizes may be provided.

The controller may be further arranged to detect tampering with the camera, and to disable the storage medium if tampering is detected. Tampering may include unauthorized opening of the camera housing or an unauthorized attempt to read images stored in the storage medium.

In this embodiment the memory device is fully sealed within the camera in the factory, as is the power supply, so that the customer uses the camera as a one time or single use device, and returns it to a service centre to enable the images to be removed and processed by the service centre. The service centre breaks open the casing to download the digital storage medium, and then transfers the still images or video to a medium selected by the customer. In a typical case the customer may ask for the images or video to be burnt onto a CDROM and would then pay for the processing and take the CDROM home to be then installed on the customer's computer. However, it is equally possible to process the images, and transmit them electronically via email, or load them onto a website which the customer can access, via a password supplied to the customers for example, or to supply them in some form of other memory device such as a DVD. Alternatively again, still images may be provided to the customer as printed hard copy pictures.

Alternatively the camera may have an external connector to enable it to be connected to and downloaded at the service centre without necessarily breaking the camera casing. The PIN configuration may be unique to the camera supplier and service centre making it more difficult for a customer or “hacker” to remove and access the images and/or recycle the digital storage medium without returning the camera to the authorised service centre.

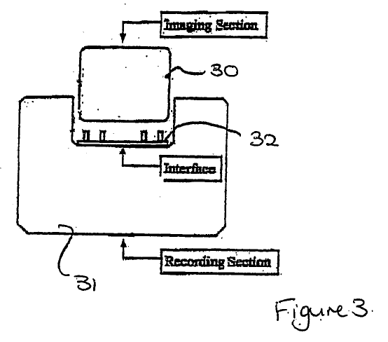

FIG. 2 illustrates a second type of camera, in this configuration the casing is designed to allow for a replaceable power supply, perhaps a single cell 1.5 volt battery. Typically a double A (AA) battery may supply sufficient power for the device over its expected lifetime. The camera has a removable memory module so that it is easier for the service centre to remove the module, and download the images. The removable memory module may have industry standard PIN connections enabling the customer to connect the memory module when full to a computer, via a docking station, or an appropriate connector. A typical example would be to use a USB connector to enable images to be downloaded to a computer. In which case it is preferable that the memory device is a read only device, which cannot be erased or refreshed by the customer.If the images stored in the storage medium are downloadable by a customer then the images may be stored in an unencrypted form and the controller need not include an encryption key.

In an alternative embodiment, the camera may include a memory device without any physical connectors, but having an in-built transponder capable of being energized by an inductive power supply or other wireless power supply so that the service centre can activate the memory device and allow the memory device to send the digital information to an appropriate receiver, preferably at a high frequency, and high data rate, to a receiver held by the service centre. The service centre may download the images, and then electronically erase the images from the memory device, without having to open the camera case. Preferably to download the camera customers must return the camera to an authorised service centre.

It is preferable that in each case the sale or lease of the one time use camera includes an appropriate license limiting the customer to use of the memory device until it is full, and then encouraging the customer to return it to a service centre. It may be possible to give the customer a returnable deposit, or other monetary encouragement to return the camera to the service centre. For example a partial refund may be given to the customer upon return of the camera.

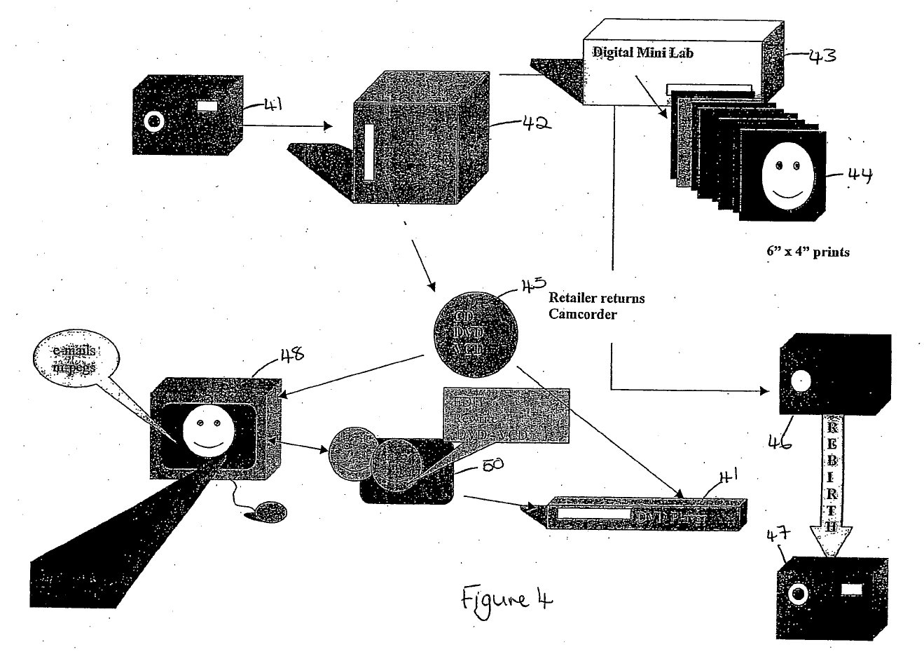

FIG. 3 shows a camera with a removable imaging module 30 which includes lens, image viewer, microphone and auditory circuitry. Memory module 31 includes memory device, controller and batteries. As shown in FIG. 3, the imaging module and memory module are connected together at interface 32. This interface may be a set of pins or any other suitable interface. Alternatives include a cable connecting the imaging module to the memory module so that the imaging module and memory module may be separate. For example, the memory module may be worn on the belt of the user. In another alternative embodiment the imaging module and memory module are in wireless communication. In this case both the imaging and memory modules include wireless transceivers and the imaging module further includes a power source such as batteries.

In this embodiment the memory module is preferably factory sealed and contains a limited amount of usable memory. When the user wishes to retrieve images from the memory, the user must return the memory module to a recycling centre. At the recycling centre the user is provided with the images in any suitable form and the memory module is then recycled. As described previously the controller and the memory module ideally encrypts data provided by the imaging section before storing it in the memory. Memory modules of different sizes and capacities may be provided to a user with the lens module at different costs.

The lens module may also be recyclable and may either be recycled together with the memory module or separately. Lens modules may be provided in a different range of sizes and qualities so that a user may buy a high quality lens module and use many memory modules with the same lens module before recycling the lens module. This allows for a range of possible digital cameras with different lens qualities and different sizes of memory.

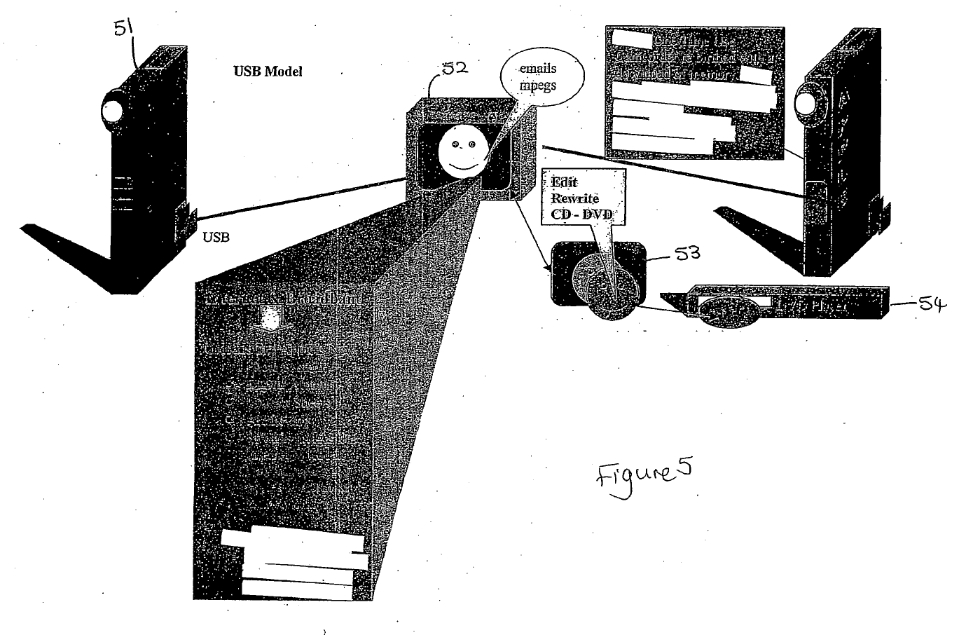

FIG. 4 shows a first embodiment of recycling system of the invention. When a user has returned the digital camera to a recycling centre, images are downloaded from the digital camera using download device 42. If the images are encrypted the download device decrypts the images. The download device may send copies of still images to a printer 43 and provide copies of the still images 44 to the user.

Download device 42 may also provide both still and video images as a CD, DVD or any other suitable format to the user. If the download device 42 provides the user with a CD or DVD or other suitable form of memory to the user then once the DVD, CD, etc, has been cut and the download device has verified the CD or DVD has been cut correctly, the download device 42 may instruct camera 41 to delete the camera memory and to rewrite the memory with random information. In this case once the memory and digital camera 41 has been rewritten the camera is then sent to a recycling centre and rebirthed as shown in steps 46 and 47.

The user is free to do what they like with the CD or DVD of images and the still prints. In an alternative embodiment the download device may email the images to the user at the user's email address. Alternatively the download device may put the images onto a website and provide the user with a password so that the user and any one provided with the password by the user can access the website. If the user is provided with a CD or DVD, the user may play the DVD in a DVD player or use a computer to read the CD or DVD.

Ideally when the user returns camera 41 to a retail outlet, the user is provided with a refund as a partial refund of the cost of the camera. This provides an incentive for the user to return the camera to the retailer.

In an alternative embodiment the user is able to download images from the camera themselves but not re-record more images onto the camera. Collection locations for used digital cameras may offer a partial refund upon return of cameras and again send the cameras to a recycling centre to be recycled so that they can be resold for re-recording.

At a recycling centre, the casing of the camera may be replaced. Other perishables such as the lens and batteries may also be replaced and the camera repackaged in a new housing. If the camera includes an encryption key, the recycling centre may provide a new encryption key to the camera. If the camera has a read only or write once memory, this memory may be erased and reset at the recycling centre so that new images may be recorded onto the memory.

FIG. 5 shows a second recycling system of the invention. In the recycling system shown in FIG. 5 a camera is provided to a user with a certain amount of usable memory. The user is able to download images from the camera to a computer and edit the images as required.

A connection between the camera 51 and computer 52 may be provided by for example a USB connection or alternatively any other suitable connection.

In this embodiment the camera is provided with a memory that is written once and cannot be rewritten over until certain instructions are received by the memory controller. To reuse the camera the user can either take the camera to a retail centre and have the memory cleared at the retail centre. Alternatively the user can log onto a website and order a program to erase the memory. If the user chooses the website option once the user had paid for the program, the program will be delivered to the user's computer via the internet and the user can download the program to camera 51 using the connection between the computer 52 and camera 51.

In one embodiment camera 51 is provided with a USB port and connects via a USB connection to computer 52. Camera 51 stores images that can be read by a photo system on the computer, for example Apple's I Photo System. This allows the user to create digital albums, contact sheets, archiving and streams of images via the Internet. If the user has the correct equipment, the user can also write the images to CD or DVD. The user can further send the images to a photo lab for good quality hard copies or provide the photo lab with the CD of images.

The foregoing describes the invention including preferred forms thereof. Alterations and modifications as well be obvious to those skilled in the art are intended to incorporated within the scope hereof as defined in the accompanying claims.

1. A recyclable digital camera including a casing, a lens housed within the casing, an encoding device arranged to encode information from the lens into a format suitable for storing in a storage device, a storage device arranged to store information from the encoder, at least one power source arranged to provide power to the encoding device, storage device and a controller, and a controller arranged to encrypt information from the encoding device before the information is stored in the storage device, the controller further arranged to delete information from the storage device and record over the storage device with random information upon request.

2. A recyclable digital camera as claimed in claim 1 wherein the controller is further arranged to detect tampering.

3. A recyclable digital camera as claimed in claim 2 wherein the controller is arranged to deactivate the storage device if tampering is detected.

4. A recyclable digital camera including a casing surrounding an image module and housing, a lens, an image viewer, a microphone, auditory circuitry, and an encoding device arranged to encode information from the lens into a format suitable for storing in a storage device, the camera further including a casing surrounding a memory module and housing at least one power source, a storage device arranged to store information from the encoder, and a controller arranged to encrypt information from the encoding device before the information is stored in the storage device, the controller further arranged to delete information from the storage device and record over the storage device with random information upon request.

5. A recyclable digital camera as claimed in claim 4 wherein the controller is further arranged to detect tampering.

6. A recyclable digital camera as claimed in claim 5 wherein the controller is arranged to deactivate the storage device if tampering is detected.

7. A recyclable digital camera including a casing, a lens housed within the casing, an encoding device arranged to encode information from the lens into a format suitable for storing in a storage device, and a storage device arranged to store information from the encoder and a controller arranged to allow the memory to become filled with images and then to prevent further images being stored on the storage device and prevent deletion of images from the storage device until a predetermined instruction is received.

8. A camera exchange system including a plurality of single use digital cameras each camera able to record both video and still images, each camera including a controller that encrypts the images stored in memory, at least one receiving station arranged to read the images from a camera memory, decrypt the images and provide the images to a user in a required form, and at least one recycling station for recycling used cameras by at least replacing the camera case.

9. A camera exchange system as claimed in claim 8 wherein the receiving station provides images to the user in the form of pictures.

10. A camera exchange system as claimed in claim 8 wherein the receiving station provides images to the user as a video.

11. A camera exchange system as claimed in claim 8 wherein the receiving station provides images to the user as a CD.

12. A camera exchange system as claimed in claim 8 wherein the receiving station provides images to the user as a DVD.

13. A camera exchange system as claimed in claim 8 wherein the receiving station provides images to the user as an email.

14. A camera exchange system as claimed in claim 8 wherein the receiving station provides images to the user on a website.

15. A camera exchange system as claimed in claim 8 wherein the recycling station provides the camera with a new encryption key.

16. A camera exchange system as claimed in claim 8 wherein the encryption key used by the camera is a 32-bit rolling encryption key.

17. A camera exchange system as claimed in claim 8 wherein the receiving station instructs the camera to delete images stored in the camera once the images have been provided to a user.

18. A camera exchange system as claimed in claim 8 wherein the receiving station further instructs the camera to overwrite any data stored in the camera memory after the camera has deleted images stored in the camera.

19. A camera exchange system as claimed in claim 8 wherein a refund is provided to the user when the user provides the receiving station with a camera.

20. A camera exchange system as claimed in claim 8 wherein the camera further includes a controller arranged to detect tampering.

21. A camera exchange system as claimed in claim 20 wherein the controller is arranged to deactivate the storage device if tampering is detected.

22. A camera exchange system as claimed in claim 8 wherein at the recycling station the lens of the camera is replaced.

23. A camera exchange system as claimed in claim 8 wherein at the recycling station the battery of the camera is replaced.

24. A camera exchange method including providing a plurality of single use digital cameras each camera able to record both video and still images, each camera including a controller arranged to encrypt the images stored in the memory of the camera, receiving at least one camera at a receiving station the receiving station arranged to read the images from the camera memory, decrypt the images and provide the images to a user in a required form, and recycling the at least one camera at a recycling station.

25. A camera exchange method as claimed in claim 24 wherein the receiving station provides images to the user in the form of pictures.

26. A camera exchange method as claimed in claim 24 wherein the receiving station provides images to the user as a video.

27. A camera exchange method as claimed in claim 24 wherein the receiving station provides images to the user as a CD.

28. A camera exchange method as claimed in claim 24 wherein the receiving station provides images to the user as a DVD.

29. A camera exchange method as claimed in claim 24 wherein the receiving station provides images to the user as an email.

30. A camera exchange method as claimed in claim 24 wherein the receiving station provides images to the user on a website.

31. A camera exchange method as claimed in claim 24 wherein the recycling station provides the camera with a new encryption key.

32. A camera exchange method as claimed in claim 24 wherein the encryption key used by the camera is a 32-bit rolling encryption key.

33. A camera exchange method as claimed in claim 24 wherein the receiving station instruction the camera to delete images stored in the camera once the images have been provided to a user.

34. A camera exchange method as claimed in claim 24 wherein the receiving station further instructs the camera to overwrite any data stored in the camera memory after the camera has deleted images stored in the camera.

35. A camera exchange method as claimed in claim 24 wherein a refund is provided to the user when the user provides the receiving station with a camera.

36. A camera exchange method as claimed in claim 24 wherein the camera further includes a controller arranged to detect tampering.

37. A camera exchange method as claimed in claim 36 wherein the controller is arranged to deactivate the storage device if tampering is detected.

38. A camera exchange method as claimed in claim 24 wherein at the recycling station the lens of the camera is replaced.

39. A camera exchange method as claimed in claim 24 wherein at the recycling station the battery of the camera is replaced.
